(19) United States
(12) Patent Application Publication
(10) Pub. No.: US 2019/0383520 A1
(43) Pub. Date: Dec. 19, 2019

(54) DRIVE MECHANISMS FOR SOLAR CONCENTRATORS, AND ASSOCIATED SYSTEMS AND METHODS

(71) Applicant: GlassPoint Solar, Inc., Fremont, CA (US)

(72) Inventors: Hayden Graham Burvill, San Carlos, CA (US); Dylan Miller Fairbanks, Alameda, CA (US); Peter Emery von Behrens, Oakland, CA (US); Jonathan A. Smith, Fremont, CA (US); Kurt H. Weiner, Fremont, CA (US)

(21) Appl. No.: 16/255,305

(22) Filed: Jan. 23, 2019

Related U.S. Application Data
(60) Provisional application No. 62/621,381, filed on Jan. 24, 2018.

(51) Int. Cl. F24S 30/00; G05D 3/10

(52) U.S. Cl. CPC F24S 30/00; G05D 3/105; H02S 20/32; F24S 2030/15; F24S 2030/133

(57) ABSTRACT

Drive mechanisms for solar concentrators, and associated systems and methods are disclosed. A representative solar energy collection system includes an at least partially transparent enclosure, a receiver positioned in the enclosure to receive solar radiation passing into the enclosure, a concentrator positioned within the enclosure to focus incoming solar radiation on the receiver, and a drive system operatively coupled to the concentrator to rotate the concentrator relative to the receiver. The drive system can include a drive chain operatively coupled to the concentrator, a drive gear engaged with the drive chain, and a drive motor coupled to the drive gear to rotate the drive gear and rotate the concentrator relative to the receiver.

### CROSS-REFERENCE TO RELATED APPLICATION

The present application claims priority to pending U.S. Provisional Application No. 62/621,381, filed Jan. 24, 2018 and incorporated herein by reference.

### TECHNICAL FIELD

The present technology is directed generally to drive mechanisms for solar concentrators, and associated systems and methods.

### BACKGROUND

As fossil fuels become more scarce, the energy industry has developed more sophisticated techniques for extracting fuels that were previously too difficult or expensive to extract. One such technique is to inject steam into an oil-bearing formation to free up and reduce the viscosity of the oil. Several techniques for steam injection presently exist, and are often referred to collectively as “Thermal Enhanced Oil Recovery,” or “Thermal EOR.” Representative steam injection techniques include cyclic, steamflood, steam-assisted gravity drainage (SAGD), and other strategies using vertical and/or horizontal injection wells, or a combination of such wells, along with continuous, variable-rate, and/or intermittent steam injection in each well.

One representative system for generating steam for steam injection is a fuel-fired boiler, having a once-through configuration or a recirculating configuration. Other steam generating systems include heat recovery steam generators, operating in a continuous mode. Thermal EOR operations often produce steam 24 hours per day, over a period ranging from many days to many years, which consumes a significant amount of fuel. Accordingly, another representative steam generator is a solar steam generator, which can augment or replace fuel-fired boilers. Solar steam generators can reduce fuel use, reduce operations costs, reduce air emissions, and/or increase oil production in thermal recovery projects.

A representative solar energy system in accordance with the prior art includes multiple solar concentrators that concentrate incoming solar radiation onto corresponding receivers. Accordingly, the solar concentrators have highly reflective (e.g., mirrored) surfaces that redirect and focus incoming solar radiation onto the receivers. The receivers can take the form of elongated conduits or pipes. The receivers receive water that is heated to steam by the concentrated solar radiation provided by the concentrators. The concentrators and receivers can be housed in an enclosure that protects the concentrators from wind, dust, dirt, contaminants, and/or other potentially damaging or obscuring environmental elements that may be present in the local environment. The enclosure has supports from which the receivers are suspended, and the concentrators can in turn be suspended from the receivers. The concentrators can rotate relative to the receivers so as to track the motion of the sun, on a daily and/or seasonal basis. A representative drive mechanism for such a concentrator includes a motor connected to one or more cables that rotate the concentrator to track the motion of the sun.

While the foregoing arrangement provides suitable thermal energy to end users, the inventors have identified several techniques that significantly improve the performance of the system, and particularly the concentrator drive mechanism, as discussed in further detail below.

### BRIEF DESCRIPTION OF THE DRAWINGS

FIG. 1 is a partially schematic, isometric view of a system that includes an enclosure, with concentrators and receivers supported within the enclosure in accordance with some embodiments of the present technology.

FIG. 2A is a partially schematic, end view of an enclosure housing a solar concentrator driven by a drive mechanism configured in accordance with embodiments of the present technology.

FIG. 2B is a partially schematic, enlarged illustration of a portion of the drive mechanism shown in FIG. 2A.

FIG. 3A is a partially schematic, end view of an enclosure housing a solar concentrator driven by a drive mechanism having a ground-based motor, in accordance with representative embodiments of the present technology.

FIG. 3B is a partially schematic, enlarged illustration of a portion of the drive mechanism shown in FIG. 3A.

FIG. 4A is a partially schematic, end view of an enclosure housing a solar concentrator driven by a drive mechanism that includes a continuous chain, in accordance with embodiments of the present technology.

FIGS. 4B and 4C illustrate enlarged views of portions of the drive mechanism show in FIG. 4A.

FIG. 5 is a partially schematic illustration of a system that includes multiple solar concentrators driven by a single motor, in accordance with embodiments of the present technology.

### DETAILED DESCRIPTION

### 1.0 Overview

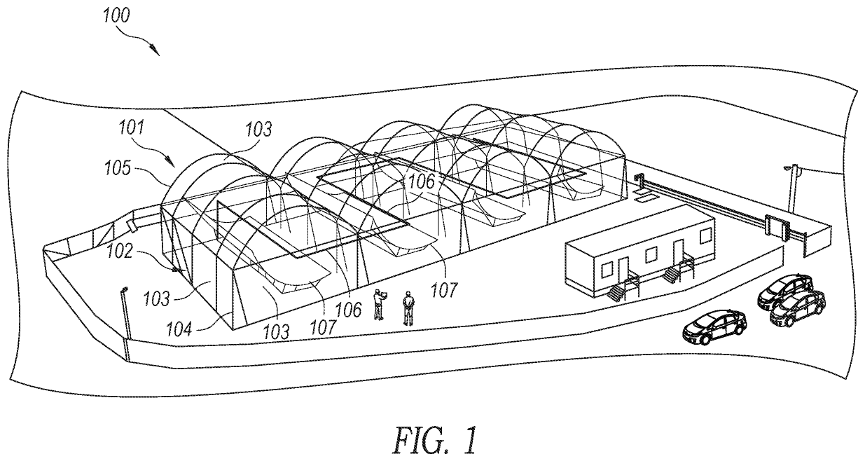

The present technology is directed generally to drive mechanisms and other equipment used to rotate solar concentrators relative to solar receivers, and associated systems and methods. The solar concentrators can be used for heating a fluid for a variety of processes including power generation, heating, and/or solar enhanced oil recovery. Specific details of some embodiments of the disclosed technology are described below with reference to a system configured for oil well steam injection to provide a thorough understanding of these embodiments, but in some embodiments representative systems can be used in other contexts, e.g., to provide steam for power generation and/or process heat. Several details describing structures or processes that are well-known and often associated with steam generation systems, but that may unnecessarily obscure some significant aspects of the present technology are not set forth in the following description for purposes of clarity. Moreover, although the following disclosure sets forth several embodiments of different aspects of the presently disclosed technology, several other embodiments of the technology can have configurations and/or components different than those described in this section. Accordingly, the presently disclosed technology may include embodiments with additional elements and/or without several of the elements described below with reference to FIGS. 1-5.

Aspects of the present technology improve upon the prior art in one or more of several areas. These areas include providing smooth, reliable, and/or repeatable rotation for solar concentrators, while at the same time facilitating high rotation angles for the solar concentrators, without unnecessarily compromising on concentrator stability. Other areas include reducing part count and system cost, for example, by driving multiple concentrators with a single motor.

Some embodiments of the disclosed technology may take the form of computer-executable instructions, including routines executed by a programmable computer or controller. Those skilled in the relevant art will appreciate that the technology can be practiced on computer or controller systems other than those shown and described herein. The technology can be embodied in a special-purpose computer, controller, or data processor that is specifically programmed, configured, or constructed to perform one or more of the computer-executable instructions described below. Accordingly, the terms “computer” and “controller” as generally used herein include a suitable data processor and can include internet appliances and hand-held devices, including palm-top computers, wearable computers, cellular or mobile phones, multi-processor systems, processor-based programmable consumer electronics, network computers, laptop computers, mini-computers, and the like. Information handled by these computers can be presented at any suitable display medium, including a liquid crystal display (LCD) and/or a touchscreen. As is known in the art, these computers and controllers commonly have various processors, memories (e.g., non-transitory computer-readable media), input/output devices, and/or other suitable features.

The present technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the present technology are also encompassed within some embodiments of the present technology.

### 2.0 Representative Drive Systems and Associated Methods

FIG. 1 is a partially schematic isometric illustration of a system 100, including an enclosure 101 housing solar concentrators 107 and receivers (e.g., elongated tubes, pipes, and/or conduits) 106. The solar concentrators 107 can have a trough-type configuration (e.g., a parabolic trough) as shown in FIG. 1, or other suitable configurations (e.g., point concentrators and/or Fresnel lenses). In some embodiments, the enclosure 101 includes a support structure 102 that in turn includes curved support members 105 supported by uprights 104, which together support one or more transparent thin film sections 103 in a tensioned arrangement to protect the interior of the enclosure 101. Inside the enclosure 101, the multiple concentrators 107 direct incoming sunlight to the corresponding receivers 106 to heat water or another working fluid passing through the receivers 106. When the working fluid includes water, at least some of the water can be (but need not necessarily be) converted to steam. The heated working fluid can be used for power generation, solar enhanced oil recovery (EOR) operations, and/or other industrial processes.

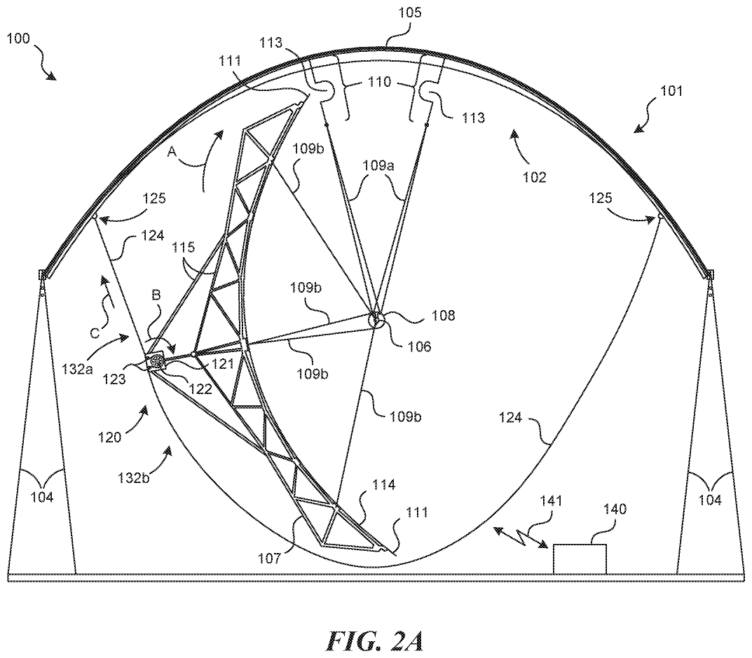

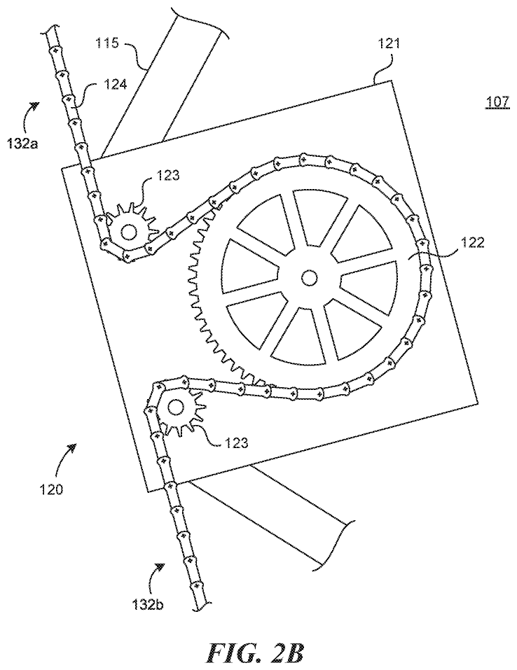

FIG. 2A is a partially schematic end view of a representative system 100 that includes an enclosure 101 generally similar to that shown in FIG. 1. The receiver 106 (seen end-on) is suspended from the support structure 102 of the enclosure 101 by receiver tension members 109a and concave suspension members 110. The concave suspension members 110 can each include an opening or concavity 113 positioned to receive an edge 111 of the concentrator 107. This arrangement can allow the receiver tension members 109a to be spaced apart from each other at a wider angle, while still accommodating large rotation angles by the concentrator 107. In some embodiments, the concave suspension members 110 can include rigid structures that are pinned to (e.g., pivotably supported by) the curved support member 105. The receiver tension members 109a can include lightweight thin rods or cables.

The concentrator 107 can include a mirrored or otherwise reflective surface 114, facing toward the receiver 106, and a frame or other support structure 115 to support the reflective surface 114 in a parabolic or other suitable curved shape.

The receiver tension members 109a connect to a bearing 108, which is in turn connected to the receiver 106. The bearing 108 acts as a support from which the concentrator 107 is suspended, via concentrator tension members 109b. Accordingly, the concentrator 107 can rotate relative to the receiver 106, as indicated arrow A.

To rotate the concentrator 107, the system 100 can include a drive mechanism 120. In an embodiment shown in FIG. 2A, the drive mechanism 120 can include a drive chain 124 (or another suitable flexible, elongated drive element) that hangs between corresponding chain attachment fixtures 125, e.g., at the curved support member 105. The drive chain 124 loops around two idler gears 123 and a drive gear 122 (or other suitable drive member), all carried by the concentrator 107. The drive gear 122 is rotated by a drive motor 121 (or other suitable actuator), also carried by the concentrator 107. As the drive motor 121 rotates the drive gear 122 clockwise, as indicated by arrow B, the drive gear 122 rolls upwardly along the drive chain 124, as indicated by arrow C. Since the drive chain 124 is fixedly attached to the enclosure 101, the drive gear 122 pulls the concentrator 107 along the drive chain 124, causing it to rotate as indicated by arrow A.

A controller 140 is operably coupled to the drive mechanism 120, for example, via a wireless or other communication link 141. Accordingly, the controller 140 can direct the drive mechanism 120 to rotate the concentrator 107 in a manner that depends upon the location of the sun in the sky.

FIG. 2B is an enlarged illustration of a portion of the drive mechanism 120, illustrating the idler gears 123 and the drive gear 122 shown in FIG. 2A. The idler gears 123 guide the drive chain 124 around the drive gear 122. Referring to FIGS. 2A and 2B together, when the concentrator 107 is in the orientation shown in FIG. 2A, an upper/left portion 132a of the drive chain 124 is in tension, and a lower/right portion 132b of the drive chain 124 is slack (or under less tension). When the concentrator 107 (FIG. 2A) rotates counter-clockwise so as to face straight up, both the left and right portions 132a, 132b are slack (or under less tension). When the concentrator 107 continues to rotate counter-clockwise, the right portion 132b becomes tensioned, while the left portion 132a remains slack (or under less tension).

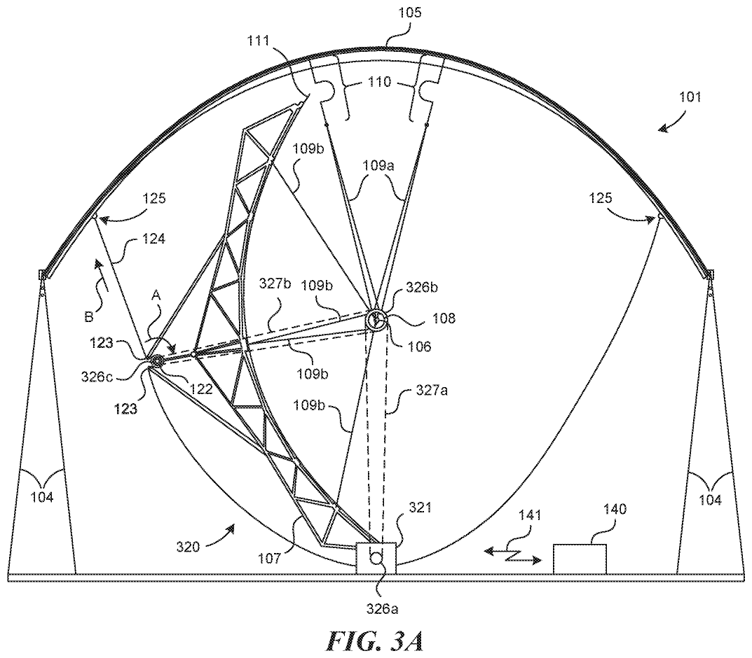

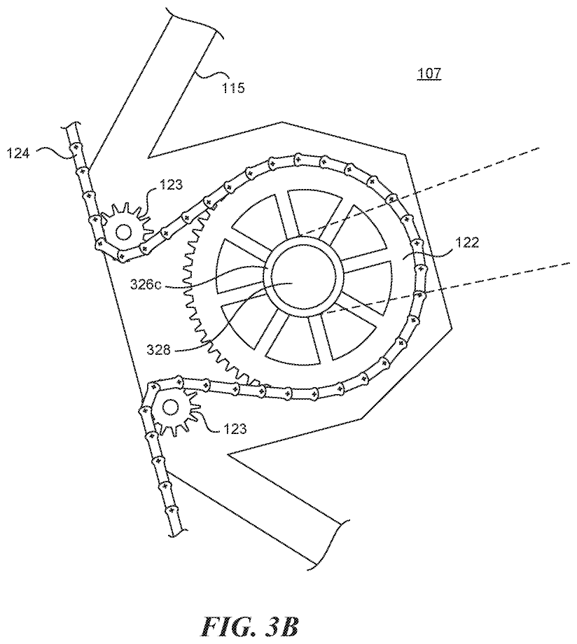

In a representative embodiment described above with reference to FIGS. 2A and 2B, the drive motor 122 is carried by the concentrator 107. In an embodiment shown in FIGS. 3A and 3B, a representative drive motor 321 is located off the concentrator 107, e.g., on the floor of the enclosure 101. The associated drive mechanism 320 can further include a drive gear 122 that, with guidance from the idler gears 123, rolls along the drive chain 124, in a manner generally similar to that described above with reference to FIGS. 2A and 2B.

Referring to FIG. 3A drive mechanism 320 can further include devices to transmit rotary power from the fixed drive motor 321 to the orbiting drive gear 122. For example, the drive system 320 can include a first pulley 326a driven by the drive motor 321 and connected to a second pulley 326b that can be concentric with, and rotate relative to, the receiver 106. A first belt 327a transmits the rotary motion from the first pulley 326a to the second pulley 326b. The second pulley 326b can include multiple sheaves, one of which receives the first belt 327a, and another of which receives a second belt 327b. The second belt 327b couples the second pulley 326b to a third pulley 326c located at the concentrator 107. The third pulley 326c is operably coupled to the drive gear 122, as shown in greater detail in FIG. 3B.

Referring now to FIG. 3B, the third pulley 326c can be carried by a drive shaft 328 that also carries the drive gear 122. The drive gear 122 pulls the concentrator 107 along the drive chain 124, aided by the idler pulleys 123, in generally the manner described above with reference to FIGS. 2A and 2B.

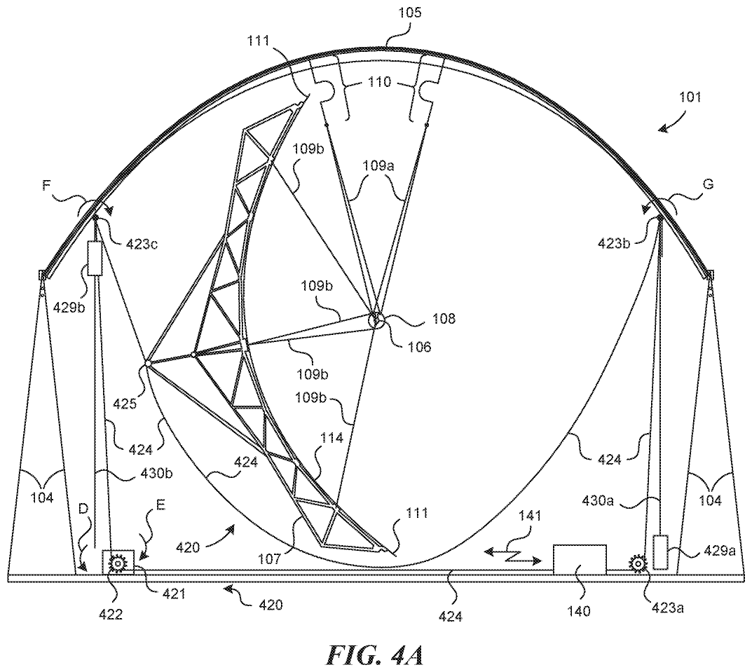

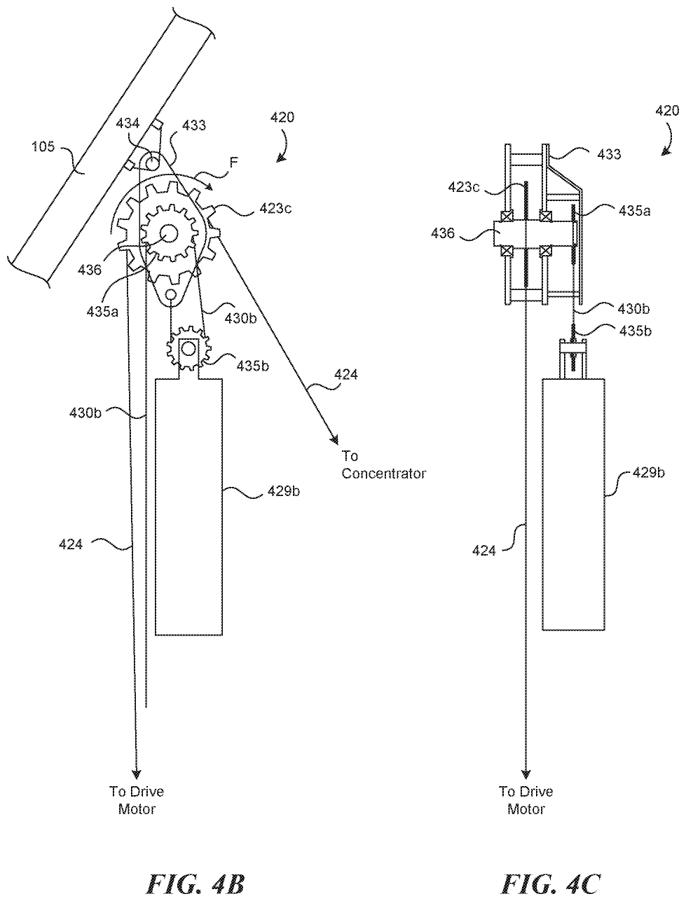

FIG. 4A illustrates a drive mechanism 420 configured in accordance with an embodiment in which the corresponding drive chain 424 forms a continuous loop. Accordingly, the drive chain 424 engages with a corresponding drive gear 422 driven by a drive motor (or other actuator) 421 positioned off the concentrator 107 (e.g., at the base of the enclosure 101). The drive chain 424 is routed around multiple idler gears 423, shown as a first idler gear 423a, a second idler gear 423b, and a third idler gear 423c. Two of the idler gears (e.g., the second and third idler gears 423b, 423c) can be positioned on opposite sides of the concentrator 107. The drive chain 424 is not attached to the enclosure 101, but is instead attached (e.g., affixed) to the concentrator 107, e.g., at a chain attachment fixture 425. When the drive gear 422 rotates counter-clockwise, as indicated by arrow D, the drive chain 424 pulls the concentrator 107 to the position shown in FIG. 4A. When the drive gear 424 rotates clockwise, as indicated by arrow E, the concentrator 107 rotates first to an upwardly facing position, and then to a position in which the reflective surface 114 faces toward the left, rather than toward the right.

The drive chain 424 can be sized so as not to interfere with the rotating motion of the concentrator 107, e.g., so as to not contact, or to only “graze” or barely contact the concentrator edges 111 as the concentrator 107 rotates. The drive mechanism 420 can also include arrangements to keep sufficient tension in even the “slack” portion of the drive chain 424 so that the drive chain 424 does not pile up on the floor of the enclosure 101. For example, the drive mechanism 420 can include first and second weights 429a, 429b at each of the second and third idler gears 423b, 423c. Each weight 429a, 429b can be attached to a corresponding weight chain 430a, 430b that operates to take up the slack. Further details are described below with reference FIGS. 4B and 4C.

FIG. 4B is an enlarged view of a portion of the drive mechanism 420 shown in FIG. 4A, in particular, the region around the third idler gear 423c. FIG. 4C is an end view of the portion of the drive mechanism 420 shown in FIG. 4B. Referring to FIGS. 4B and 4C together, the drive mechanism 420 can include a bracket 433 attached to the curved support member 105 (FIG. 4B) via a pin joint 434 (FIG. 4B). The bracket 433 can include a gear shaft 436 that carries the third idler gear 423c and a corresponding first weight gear 435a. The third idler gear 423c carries the drive chain 424, which extends in one direction (e.g., inwardly) to the concentrator, and in the other direction (e.g., outwardly) to the drive motor. The first weight gear 430b carries the second weight chain 430b, which is in turn connected to the second weight 429b via a second weight gear 435b. The opposite end of the second weight chain 430b is unattached.

in operation, the downward force provided by the second weight 429b applies a clockwise moment, indicated by arrow F, to the first weight gear 435a and, via the gear shaft 436, to the third idler gear 423c. Accordingly, if there is any slack in the drive chain 424, that slack will be forced inwardly, toward the concentrator as shown in FIG. 4B.

Returning to FIG. 4A, a similar arrangement at the second idler gear 423b applies a counter-clockwise moment, indicated by arrow G, to the second idler gear 423b, which tends to force any slack in the drive chain 424 inwardly toward the concentrator 107. As a result of the biasing force provided by both the weights 429a, 429b, any slack in the drive chain 424 is placed into the portion of the drive chain that extends between the second and third idler gears 423b, 423c hanging below the concentrator 107. This in turn has the effect of reducing or eliminating any tendency for the drive chain 424 to pile up on the floor of the enclosure 101. Instead, all the slack in the drive chain 424 is between the chain attachment feature 425 and third idler gear 423c (when the concentrator 107 is facing toward the right, as shown in FIG. 4A), and between the chain attachment feature 425 and the second idler gear 423b (when the concentrator is facing toward the left). With all the slack between the chain attachment feature 425 and the second or the third idler gear 423b, 423c, the likelihood for the drive chain 424 to place any excessive force, wear, or other loading on the concentrator 107 (e.g., at the concentrator edge 111) can be reduced or eliminated. When the concentrator 107 faces straight up (e.g., in a “neutral” position), the tension (and amount of slack) between the chain attachment feature 425 and the second idler gear 423b can be the same or approximately the same as between the chain attachment feature 425 and the third idler gear 423c.

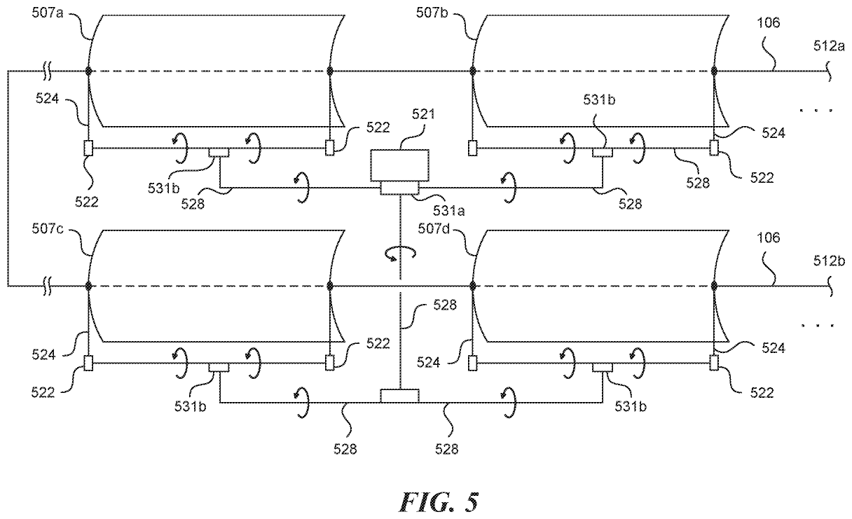

In any of the foregoing embodiments, a single motor can be used to drive multiple concentrators. In a representative arrangement shown in FIG. 5, a single motor 521 is coupled to multiple transmission units 531a, 531b, and corresponding drive shafts 528 to power multiple concentrators 507a-507d. The concentrators can be located along multiple “aisles” within an enclosure, for example a first aisle 512a (along which first and second concentrators 507a, 507b are located), and second aisle 512b along which third and fourth concentrators 507c, 507d are located. A similar arrangement can be used for different numbers of concentrators positioned along different numbers of aisles, with the general operational principal being similar to that described below.

The motor 521 can be coupled to a main transmission unit 531a that distributes rotary motion to multiple secondary transmission units 531b within the first and second aisles 512a, 512b, and across the aisles 512a, 512b. In a particular embodiment, each concentrator 507 is positioned proximate to two corresponding drive gears 522, each of which is connected/coupled to a drive chain 524 to drive the concentrator 507. Depending upon the length of the concentrator 507, an individual concentrator 507 may have more or fewer chain drive connection/coupling points to facilitate rotating the concentrator in a uniform manner, without causing undue twisting. In some embodiments, the drive shafts 528 extending from opposing sides of the main transmission unit 531a can be of equal length and diameter, and/or the drive shafts 528 extending from opposing sides of any of the secondary transmission units 531b can be of equal length and diameter. This symmetric arrangement can reduce or eliminate the likelihood for torsional differences among the drive shafts, which in turn can keep the drive chains 524 in synch and reduce the likelihood for twisting the concentrators 507. The overall stiffness of the drive shafts 524 can be reduced, thus reducing the cost of the drive shafts.

From the foregoing, it will be appreciated that representative embodiments of the present technology have been described herein for purposes of illustration, but that the technology can include suitable modifications, without deviating from the technology. For example, in some embodiments, a single pulley can include multiple sheaves, and in other embodiments, multiple pulleys, each with a single sheave can be mounted on a single shaft. In any of the foregoing embodiments, the disclosed pulley arrangements and gear arrangements can include suitable speed reduction and/or speed increasing ratios, depending upon the target output speed of the corresponding drive motor, and the desired rotation speed of the concentrator. In some embodiments, the belts and pulleys described above to transmit motion from a stationary motor to a moving concentrator, can be replaced with other suitable mechanisms. The drive chains described above can include linked chains, as illustrated, or other suitable arrangements, including, but not limited to toothed belts or other suitable flexible, elongated drive elements. Such elements can be configured to transmit loads in tension, but not compression. The brackets described above with reference to FIGS. 4B, 4C can be eliminated, with the corresponding gear shafts carried by other intermediate structures, or directly carried by the support structure of the enclosure. The arrangement of hanging weights described above for maintaining tension in the drive chain can be replaced and/or combined with other suitable arrangements, for example, spring-based tension devices.

Certain aspects of the technology described in the context of some embodiments may be combined or eliminated in other embodiments. For example, the concave suspension members can be used in conjunction with drive mechanisms other than those shown and described herein. The drive mechanisms shown and described herein can be used in conjunction with receiver/concentrator support arrangements that do not include concave suspension members. Further, while advantages associated with certain embodiments of the present technology have been described in the context of such embodiments, other embodiments may also exhibit such advantages, and not all embodiments need necessarily exhibit such advantages to fall within the scope of present technology. Accordingly, the present disclosure and associated technology can encompass other embodiments not expressly described or shown herein. The following examples provide representative embodiments in accordance with the present technology.

As used herein, the phrase “and/or” as in “A and/or B” refers to alone, B alone and both A and B. To the extent any materials incorporated herein by reference conflict with the present disclosure, the present disclosure controls.

I/we claim:

1. A solar energy collection system, comprising:
an at least partially transparent enclosure;
a receiver positioned in the enclosure to receive solar radiation passing into the enclosure;
a concentrator positioned within the enclosure to focus incoming solar radiation on the receiver; and
a drive system operatively coupled to the concentrator to rotate the concentrator relative to the receiver, the drive system including:
a drive chain operatively coupled to the concentrator;
a drive gear engaged with the drive chain; and
a drive motor coupled to the drive gear to rotate the drive gear and rotate the concentrator relative to the receiver.

2. The solar energy collection system of claim 1 wherein at least a portion of the drive chain is fixed relative to the enclosure, and wherein the drive gear and the drive motor are carried by the concentrator, with the drive gear positioned to roll along the drive chain and rotate the concentrator as the motor rotates the drive gear.

3. The solar energy collection system of claim 1 wherein the drive motor has a fixed location relative to the enclosure, and wherein the drive gear is carried by the concentrator, with the drive gear positioned to roll along the drive chain and rotate the concentrator as the motor rotates the drive gear.

4. The solar energy collection system of claim 3 wherein the drive motor is coupled to the drive gear via at least one belt and at least one pulley.

5. The solar energy collection system of claim 1 wherein the drive motor has a fixed location relative to the enclosure, and wherein the chain is connected to the concentrator and forms a continuous loop.

6. The solar energy collection system of claim 1 wherein the concentrator is suspended from the receiver, and the receiver is suspended from an overhead structure of the enclosure via a generally rigid, concave suspension member, and a tension member positioned between the suspension member and the receiver, and wherein the concentrator is rotatable relative to the receiver between a first position in which at least a portion of the receiver is located within a concave region of the suspension member, and a second position in which the concentrator is located outside the concave region.

7. A solar energy collection system, comprising:
an at least partially transparent enclosure;
a receiver positioned in the enclosure to receive solar radiation passing into the enclosure;
a concentrator positioned within the enclosure to focus incoming solar radiation on the receiver; and
a drive system operatively coupled to the concentrator to rotate the concentrator relative to the receiver, the drive system including:
an elongated, flexible drive element operatively connected to the concentrator;
a drive member positioned off the concentrator and engaged with the elongated, flexible drive element; and
an actuator coupled to the drive member to rotate the drive member and rotate the concentrator relative to the receiver, via the elongated, flexible drive element.

8. The system of claim 7 wherein the elongated, flexible drive element includes a drive chain, and wherein the drive member includes a gear.

9. The system of claim 8, further comprising:
a gear shaft carried by and rotatable relative to the enclosure;
an idler gear and a weight gear carried by the gear shaft, the idler gear being engaged with the drive chain; and
a weight chain carrying a weight and engaged with the weight gear to bias the gear shaft in a target rotational direction when the actuator directs the drive chain around the idler gear in the target rotational direction.

10. The system of claim 9, further comprising a bracket carried by the enclosure, wherein the gear shaft is carried by and rotatable relative to the bracket.

11. The system of claim 8 wherein the enclosure includes a curved support member, the receiver is suspended from the curved support member, and the concentrator is suspended from the receiver; and wherein the system further comprises:
a first idler gear carried by the curved support member and positioned on a first side of the concentrator; and
a second idler gear carried by the curved support member and positioned on a second side of the concentrator, wherein the drive chain passes over and outside both the first second idler gears, and wherein the portions of the drive chain positioned outside the first and second idler gears are in tension.

12. A method for operating a solar energy collection system, the method comprising:
concentrating, via a solar concentrator, solar energy passing into an at least partially transparent enclosure;
directing the concentrated solar energy to a receiver positioned in the enclosure; and
activating an actuator to rotate the concentrator relative to the enclosure via a drive system, the drive system including:
a drive chain operatively coupled to the concentrator; and
a drive gear engaged with the drive chain and driven by the actuator.

13. The method of claim 12 wherein at least a portion of the drive chain is fixed relative to the enclosure, and wherein the drive gear and the drive motor are carried by the concentrator, and wherein activating the actuator causes the drive gear to roll along the drive chain and rotate the concentrator.

14. The method of claim 12 wherein the drive motor has a fixed location relative to the enclosure, and wherein the drive gear is carried by the concentrator, and wherein activating the actuator causes the drive gear to roll along the drive chain and rotate the concentrator.

15. The method of claim 14 further comprising driving the drive gear via at least one belt and at least one pulley.

16. The method of claim 12 wherein the drive motor has a fixed location relative to the enclosure, and wherein the chain is connected to the concentrator and forms a continuous loop.

17. A method for operating a solar energy collection system, the method comprising:
concentrating, via a solar concentrator, solar energy passing into an at least partially transparent enclosure;
directing the concentrated solar energy to a receiver positioned in the enclosure;
activating an actuator to rotate the concentrator relative to the enclosure via a drive system, the drive system including:
a drive chain operatively connected to the concentrator and passing over and around two idler gears positioned on opposing sides of the concentrator; and
a drive gear engaged with the drive chain and driven by the actuator; and
tensioning portions of the drive chain positioned outside the two idler gears, while allowing a portion of the drive chain positioned between the idler gears to be slack.

18. The method of claim 18 wherein tensioning the portions of the drive chain positioned outside the two idler gears includes applying a rotational force to the idler gears via corresponding suspended weights.

19. The method of claim 18 wherein tensioning the portions of the drive chain positioned outside the two idler gears includes preventing the portions of the drive chain from piling up on a floor of the enclosure.

20. The method of claim 18 wherein allowing a portion of the drive chain positioned between the idler gears to be slack includes allowing a first portion of the drive chain between a first one of the idler gears and the concentrator to be slack while tensioning a second portion of the drive chain between a second one of the idler gears and the concentrator.

21. The method of claim 18, further comprising preventing contact between the drive chain and the concentrator while activating the actuator.
